(19) United States
(12) Patent Application Publication
(10) Pub. No.: US 2016/0116670 A1
(43) Pub. Date: Apr. 28, 2016

(54) MULTI-PARAMETER OPTICAL SENSOR AND METHOD FOR OPTICAL SENSOR MANUFACTURING

(71) Applicants: Ehsan TOYSERKANI, Waterloo (CA); Tian You Richard LIANG, Toronto (CA); Amir AZHARI, Waterloo (CA)

(72) Inventors: Ehsan TOYSERKANI, Waterloo (CA); Tian You Richard LIANG, Toronto (CA); Amir AZHARI, Waterloo (CA)

(21) Appl. No.: 14/893,573

(22) PCT Filed: May 26, 2014
(86) PCT No.: PCT/CA2014/050492

§ 371 Date: Nov. 24, 2015

Related U.S. Application Data
(60) Provisional application No. 61/827,200, filed on May 24, 2013.

(51) Int. Cl. G02B 6/02; G01L 1/24; G01K 11/32

(52) U.S. Cl. CPC G02B 6/02209; G01K 11/3206; G01L 1/246

(57) ABSTRACT

A dual-parameter optical sensor having: a fiber optic cable; a fiber Bragg grating (FBG) section provided on the fiber optic cable; and a sleeve affixed to the fiber optic cable such that the sleeve encloses a predetermined portion of the FBG section, wherein the sleeve has a different thermal expansion co-efficient than the fiber optic cable. A method for manufacturing the dual-parameter optical sensor including selecting a fiber optic cable having a predetermined thermal expansion coefficient; forming a fiber Bragg grating (FBG) section on the fiber optic cable; selecting a sleeve having a predetermined thermal expansion co-efficient that is different from the thermal expansion co-efficient of the fiber optical cable; selecting a predetermined portion of the FBG section to be enclosed by the sleeve; and joining the fiber optic cable to the sleeve such that the sleeve encloses the selected predetermined portion of the FBG section.

### FIELD

The present disclosure relates generally to optical fiber sensors and more particularly, to multi-parameter or dual-parameter optical sensors and methods for their manufacture.

### BACKGROUND

Optical fiber sensors, specifically those using optical fiber Bragg gratings (FBG), are known in the art. FBG is a type of optical sensor whose spectral response is affected by applied strain and temperature. As a result, known FBGs can be used to measure a change in either strain or temperature. The unique features of optical fiber sensors, such as FBGs, have encouraged the use of optical fiber-based sensing devices in various applications. Some of the useful features of optical fiber sensors include light weight, small size, long-term durability, long-range linearity, robustness to electromagnetic disturbances, and resistance to corrosion. There are also some limitations and challenges associated with conventional FBG sensors and their applications. One of the challenges associated with conventional FBG sensors is the coupling of the effects of strain and temperature in the optical response of the sensors, which may affect the reliability and accuracy of the measurements.

U.S. patent application Ser. No. 13/384,275 (hereinafter “the '275 patent application”) published as Publication No. 2012/0177319A1 on Jul. 12, 2012 to Alemohammad et al., which is incorporated herein by reference in its entirety, describes an optical fiber sensor and methods of manufacture. The '275 patent application describes a superstructure FBG by laser-assisted direct writing of on-fiber metallic films. A laser direct write method is used to fabricate periodic films of silver nanoparticles on the non-planar surface of as-fabricated FBGs. Silver films with a thickness of about 9 micron are fabricated around a Bragg grating optical fiber. The performance of the superstructure FBG is studied by applying temperature and tensile stress on the fiber. An opto-mechanical model is also developed to predict the optical response of the synthesized superstructure FBG under thermal and structural loadings. The reflectivity of sidebands in the reflection spectrum can be tuned up to 20% and 37% under thermal and structural loadings, respectively. In addition, the developed superstructure FBG is used for simultaneous measurement of multiple criteria such as force and temperature to eliminate the inherent limitation of conventional FBGs in multi-parameter sensing.

The '275 patent application describes modeling, design, and fabrication of FBG-based sensing devices. These sensing devices can be used for structural measurements, failure diagnostics, thermal measurements, pressure monitoring, as well as in medical devices, for example, those used for diagnosing cancer. Other applications such as structural health monitoring of aerospace structures, bridge structures, buildings, downhole measurements in oil and gas wells, and seismic vibration measurements are possible. The '275 patent application also describes an optical fiber sensor that is capable of simultaneously detecting and measuring more than one criteria at one or more locations on the optical fiber using a single data source. In order to make the most effective use of the type of multiple parameter optical fiber sensor of the '275 patent application, improved multi-parameter or dual-parameter sensors and methods of manufacturing and packaging the optical fiber sensor are needed to provide the ability to use the sensor in various applications and assist with providing more accurate sensor reading.

### SUMMARY

The present disclosure provides for a dual-parameter optical sensor and method for dual-parameter optical sensor manufacturing.

In one aspect herein, there is provided a dual-parameter optical sensor including: a fiber optic cable; a fiber Bragg grating (FBG) section provided on the fiber optic cable; and a sleeve affixed to the fiber optic cable such that the sleeve encloses a predetermined portion of the FBG section, wherein the sleeve has a different thermal expansion co-efficient than the fiber optic cable.

In some cases, the sleeve includes metal selected from the group consisting of invar, aluminum, stainless steel, and magnesium. In other cases, the sleeve includes graphene. In further cases, the sleeve has a diameter in the range of approximately 200 microns to 1 mm and the sleeve has a length in the range of 1 mm to 2 cm. In another case, the sleeve may be formed from a commercially available needle.

In some cases, the predetermined enclosed portion of the FBG section is longer than an unenclosed portion of the FBG section. In a further case, the ratio of the unenclosed portion of the FBG section to the entire FBG section is approximately less than or equal to 0.5:1.

In some cases, an optical response of the sensor provides two peaks, a first peak B1 and a second peak B2, the dual parameters are temperature (T) and pressure (F) and the parameters are calculated using the following relationship:

$$[ \begin{matrix}Δ F \\ Δ T\end{matrix} ] = {[ K ]}^{- 1} ⌊ \begin{matrix}Δ {λ}_{{B}_{1}} \\ Δ {λ}_{{B}_{2}}\end{matrix} ⌋$$

where K is a calibration matrix determined by calibrating the optical sensor.

In another aspect, a dual-parameter optical sensor is provided wherein the dual-parameter optical sensor has: a fiber optic cable; a fiber Bragg grating (FBG) section provided on the fiber optic cable; and a coating affixed to the fiber optic cable such that the coating encloses at least a predetermined portion of the FBG section, wherein the coating has a different thermal expansion co-efficient than the fiber optic cable; at least one mechanical element attached to the fiber optic cable and configured to move axially when the optical sensor is placed under pressure; and an enclosure enclosing the coating, the mechanical element and at least a portion of the fiber optic cable.

In some cases, the enclosure includes a polymer. The polymer may be selected from the group comprising a high density polyethylene, polyurethane, hytrel, polybutylene, or composite graphene-polymer.

In further cases, the coating has a conic or parabolic profile.

In some cases, the dual-parameter optical sensor also has a fixed end piece joined to a portion of the sleeve; and the mechanical element includes a moving end piece slidably engaged with the enclosure. In further cases, the fixed end piece and the moving end piece define a space between the fixed end piece and the moving end piece, and the enclosure includes a hole for providing access to the space.

In a further aspect, a method for manufacturing a dual-parameter optical sensor is provided, the method includes: selecting a fiber optic cable having a predetermined thermal expansion coefficient; forming a fiber Bragg grating (FBG) section on the fiber optic cable; selecting a sleeve having a predetermined thermal expansion co-efficient that is different from the thermal expansion co-efficient of the fiber optical cable; selecting a predetermined portion of the FBG section to be enclosed by the sleeve; and joining the fiber optic cable to the sleeve such that the sleeve encloses the selected predetermined portion of the FBG section.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows an embodiment of a dual-parameter optical sensor and packaging thereof;

FIG. 2 shows another embodiment of a dual-parameter optical sensor and packaging thereof;

FIG. 3 shows yet another embodiment of a dual-parameter optical sensor and packaging thereof;

FIG. 4 shows still yet another embodiment of a dual-parameter optical sensor;

FIG. 5 is a graph showing an optical spectrum of the dual-parameter optical sensor of FIG. 4;

FIG. 6A is a graph showing the temperature sensitivity associated with a second peak of the dual-parameter optical sensor of FIG. 4.

FIG. 6B is a graph showing the force sensitivity associated with the second peak of the dual-parameter optical sensor of FIG. 4.

FIG. 7A is a graph showing the temperature sensitivity associated with a first peak of the dual-parameter optical sensor of FIG. 4.

FIG. 7B is a graph showing the force sensitivity associated with the first peak of the dual-parameter optical sensor of FIG. 4; and

FIGS. 8A and 8B illustrate a model validation of the performance of the dual-parameter optical sensor of FIG. 4.

### DETAILED DESCRIPTION

Generally, the present disclosure provides a system and method for dual-parameter optical sensor packaging. The disclosure also provides information on an embodiment of a new optical sensor. In particular, several embodiments herein relate to a system and method of packaging that allow for the translation of pressure in the environment of the sensor to an axial force acting on an optical fiber sensor. The embodiments described are intended to be particularly useful in environments of high temperature and pressure such as, for example, oil sands monitoring and in carbon sequestration operations.

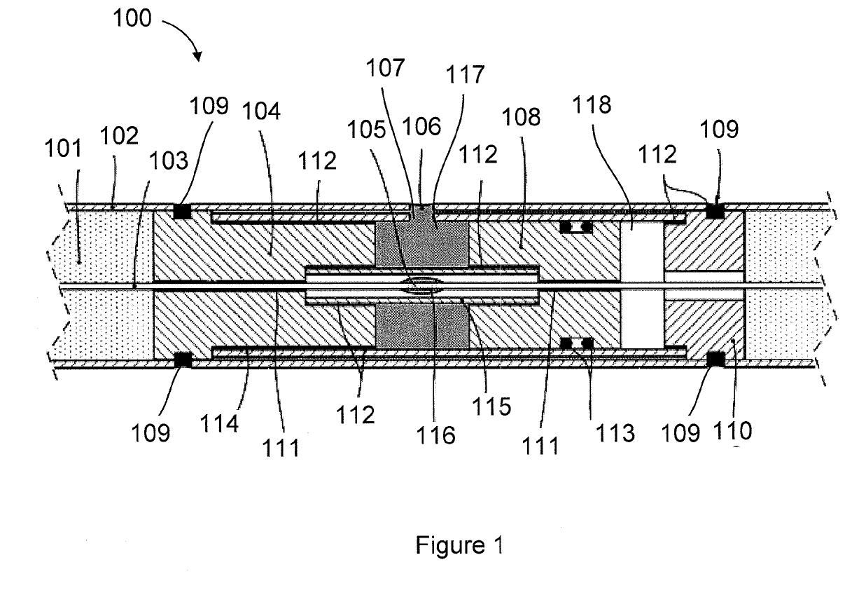

FIGS. 1 to 4 illustrate four embodiments of a dual-parameter optical sensor and associated packaging 100, 200, 300, and 400. The sensors 100, 200, 300 and 400 are intended to allow the conversion of pressure to axial force to provide a dual-parameter optical sensor that can sense both temperature and pressure. The sensors 100, 200, 300 and 400 make use of, for example, a dual-parameter optical sensor of the type described in the '275 patent application. In some embodiments, the sensors 100, 200, 300 and 400 are configured to convert external high pressure to axial force with a desired sensitivity while being placed in an environment with a predetermined operating temperature range. The dual-parameter optical sensor in these embodiments is intended to operate between the temperatures of approximately −30° C. to 300° C. The range of pressure in which the optical sensor operates may be selected based on the size of the optical sensor. In a particular example, the external high pressure may be approximately 3500 pounds-per-square-inch(psi), the desired sensitivity may be approximately 0.2 to 0.3 picometers(pm)/psi measured in reflected peak shift, and the operating temperature may be up to approximately 300° C.

FIG. 1 illustrates an example embodiment of the dual-parameter optical sensor 100. The sensor 100 includes a polymer foam 101, an outer pipe 102, a fiber optic cable 103, a fixed end piece 104, a Fiber Bragg Grating (FBG) section 105, an outer pinhole 106, an inner pinhole 107, an end piece 108, at least one aperture 109, an end cap 110, an inner heat cure epoxy 111, an outer heat cure epoxy 112, at least one O-ring 113, an inner pipe 114, a sleeve 115, and a coating 116.

The outer pipe 102 may be composed of, for example, SS-316 (Stainless Steel-Grade 316) pipe with a ⅜″ diameter. The fixed end piece 104 may be composed of, for example, Invar (FeNi36). In a particular case, the FBG section 105 may have a length in the range of, for example, 3 mm to 10 mm. The outer pinhole 107 and the inner pinhole 107 may be aligned and used, for example, for a high pressure entry point. The end piece 108 may slide or move relative to the outer pipe 102. The end piece 108 may be composed of, for example, Invar. The at least one aperture 109 may be used for, for example, injection of sealing epoxy. The sealing epoxy may be, for example, any general purpose heat cure epoxy for binding metal with metal. The end cap 110 may be composed of, for example, SS-316. The inner heat cure epoxy 111 may be composed of, for example, any general purpose epoxy for binding metal with silica. The outer heat cure epoxy 112 may be composed of, for example, any general purpose epoxy for binding metal with metal. The inner pipe 114 may be composed of, for example, SS-316 with a diameter of ¼″. The sleeve 115 may be composed of, for example, Invar. The coating 116 may be any suitable shape, for example, a conic-shaped coating or a parabolic profiled coating.

In a method for manufacturing or packaging an optical sensor, the fiber optic cable 103, which has had a FBG 105 section formed and a coating 116 applied, is positioned such that the FBG section 105 is encapsulated approximately in the center of the sleeve 115. The fixed end piece 104 and the sliding end piece 108 are attached to the fiber optic cable 103 and the sleeve 115 such that a space 117 is defined in which the FBG section 105, within the sleeve 115, is centered. The fixed end piece 104 and the sliding end piece 108 may be affixed using, for example, a heat-cure epoxy or the like. The fixed end piece 104 and sliding end piece 108 may be formed with a central hole, having a diameter of approximately 0.3 mm to 0.5 mm, for feeding the fiber optic cable 103.

The fixed end piece 104 and the sliding end piece 108 are then placed in the inner pipe 114. The fixed end piece is affixed to the inner pipe 114 by a suitable epoxy or adhesive. In a further case, the fixed end piece 104 and the inner pipe 114 may be integral as one piece, or may be removably fastened to each other. The sliding end piece 108 is provided with the at least one O-ring 113 intermediate the sliding end piece 108 and the inner pipe 114. The O-ring 113 allows the sliding end piece 108 to be slidably engaged with the inner pipe 114 with a seal provided between the sliding end piece 108 and the inner pipe 114.

The above assembly is slid into the outer pipe 102 and is positioned such that the outer pinhole 106 formed in the outer pipe 102 is aligned with the inner pinhole 107 formed in the inner pipe 114 to allow access to the space 117. In other cases, there may be more than one set of aligned inner pinholes 107 and outer pinholes 106 to allow further access to the space 117. The pinholes 106, 107 can have any suitable size as long as they are not larger than the inner diameter of the inner pipe 114; in a particular case, the pinholes 106, 107 may have a size of approximately 1/16″. The end cap 110 is placed inside the outer pipe 102 with a space 118 between the end cap 110 and the sliding end piece 108. The space 118 should have a suitable length to ensure there is no interference with the end piece 110; in a particular case, the space 118 may have a length that is greater than approximately 2 mm. The outer pipe 102 includes at least one aperture 109 for attaching the fixed end piece 104 and the end cap 110 to the outer pipe 102 to hold the inner pipe in place. The end cap 110 has a center hole for the fiber optic cable 103 to pass through. The outer pipe 102 may be filled with polymer foam 101 as in other areas of the pipe.

The pinhole formed from of the inner pinhole 107 and outer pinhole 106 allows the environment around the sensor 100 to access the space 117. An elevated pressure will then apply a force to one side of the sliding end piece 108 which will place axial strain on the FBG section 105 as the sliding end piece 108 is free to move axially. The O-ring 113 is intended to provide a seal to avoid leakage such that the space 118 between the sliding end piece 108 and the end cap 110 remains sealed at atmospheric pressure.

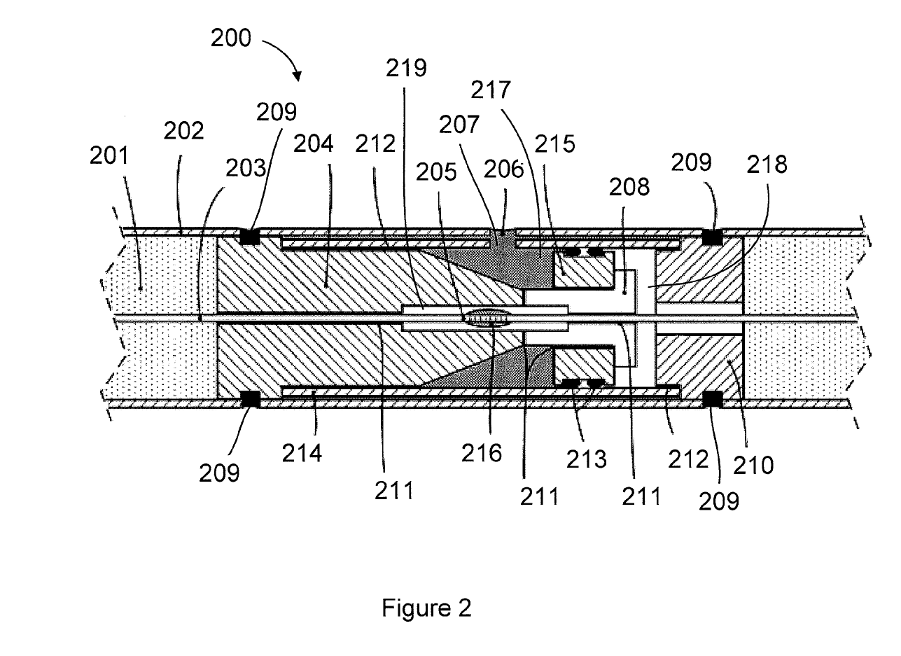

FIG. 2 illustrates a dual-parameter optical sensor 200 according to a further embodiment. The sensor 200 includes a polymer foam 201, an outer pipe 202, a fiber optic cable 203, a fixed end piece 204, a Fiber Bragg Grating (FGB) section 205, an outer pinhole 206, an inner pinhole 207, a polymer ferrule 208, at least one aperture 209, an inner heat cure epoxy 211, an outer heat cure epoxy 212, at least one O-ring 213, an inner pipe 214, an end piece 215, and a coating 216.

The outer pipe 202 may be composed of, for example, SS-316 (Stainless Steel-Grade 316) pipe with a ⅜″ diameter. The fixed end piece 204 may be composed of, for example, Invar (FeNi36). The FGB section 205 may have a length in the range of, for example, 3 mm to 10 mm. The outer pinhole 206 formed in the outer pipe 202 and the inner pinhole 207 formed in the inner pipe 214 may be aligned and used, for example, for a high pressure entry point. The at least one aperture 209 may be used for, for example, injection of sealing epoxy or adhesive. The inner heat cure epoxy 211 may be, for example, any general purpose heat cure epoxy for binding metal with polymer. The outer heat cure epoxy 212 may be, for example, any general purpose heat cure epoxy for binding metal with metal. The inner pipe 214 may be composed of, for example, SS-316 with a diameter of ¼″. The sliding/moving end piece 215 may be composed of, for example, Invar. The coating 216 may be any suitable shape, for example, a conic-shaped coating or a parabolic profiled coating.

The fiber optic cable 203, with FBG section 205 and coating 216, is encapsulated by and affixed to the fixed end piece 204 and the polymer ferrule 208 such that the FBG section 205 is enclosed in an inner space 219. The polymer ferrule 208 is affixed to a sliding end piece 215. The fixed end piece 204 and the sliding end piece 215 are then placed in the inner pipe 214. The fixed end piece is affixed to the inner pipe 214 while the sliding end piece 208 is provided with at least one O-ring 213 such that the sliding end piece 215 is slidably engaged with the inner pipe 214 providing a seal therebetween.

The above assembly is slid into the outer pipe 202 and is positioned such that the outer pinhole 206 formed in the outer pipe 202 and the inner pinhole 207 formed in the inner pipe 214 align to allow access to the space 217. In other cases, there may be more than one set of aligned outer pinholes 206 and inner pinholes 207 to allow further access to the space 217. The end cap 210, the at least one aperture 209 and the polymer foam 201 are similar to those in the embodiment of FIG. 1.

In this embodiment, pressure applied to the wall of the sliding end piece 215 is converted to axial strain on the FBG section 205 as the sliding end piece 215 is allowed to slide due to the O-rings 213. The polymer ferrule 208 elongates as the sliding end piece 215 slides. Pressure in a space 218 between the polymer ferrule 208 and the end cap 210 remains sealed at atmospheric pressure. The polymer ferrule at 208 may be configured to have a lower Young's modulus than other portions of the dual-parameter optical sensor as polymer is typically softer than metal. The strain imposed on fiber can be attenuated and optimized for the higher maximum pressure applied. As well, having a polymeric ferrule may also be cheaper to manufacture.

In the above embodiments, it will be understood that the aligned pinholes (formed from 106 and 107, or 206 and 207) and the connected space 117 or 217 may be open to the environment or may be filled with a suitable material that allows for transmission of the pressure in such a way that the same effect is created. Using a suitable material may assist with keeping the aligned pinholes (formed from 106 and 107, or 206 and 207) and the connected space 117 or 217 free of particulates and/or debris.

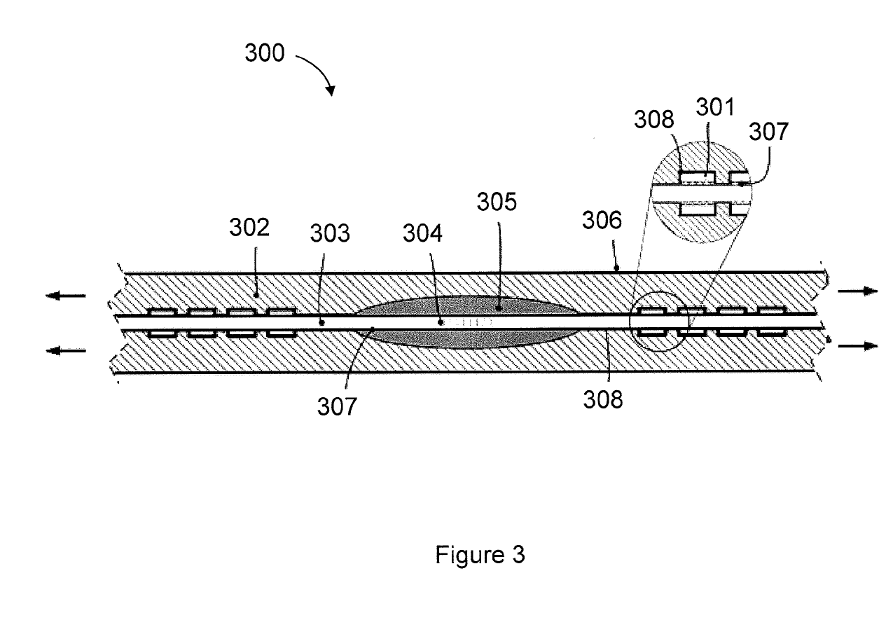

FIG. 3 illustrates a dual-parameter optical sensor 300 according to another embodiment. The sensor 300 includes a plurality of mechanical steps 301, a polymer 302, a fiber optic cable 303, a fiber Bragg grating (FBG) section 304, a coating 305, an exterior surface 306 of the polymer 302, an inner epoxy 307, and an outer epoxy 308.

The mechanical steps 301 may be composed of, for example, metallic or non-metallic beads or rings. The polymer 302 may be any suitable polymer, for example, high-density polyethylene, polyurethane, hytrel, polybutylene, composite graphene-polymer. The inner epoxy 307 may be, for example, any general purpose heat cure epoxy for binding metal with silica. The outer epoxy 308 may be, for example, any general purpose heat cure epoxy for binding polymer with silica. The coating 305 may be any suitable shape, for example, a conic-shaped coating or a parabolic profiled coating.

As above, the sensor 300 includes the fiber optic cable 303 formed with the FBG section 304 and the coating 305. The mechanical steps 301 are attached by the inner epoxy 307 to the optical fiber cable 303 on either side of the gratings 304. The fiber optic cable 303 and the mechanical steps 301 are encapsulated and surrounded by the polymer 302 such that the mechanical steps 301 are affixed to the polymer 302. A layer of the outer epoxy 308 can be injected or placed on the fiber optic cable 303 before provision of the polymer 302 to create strong bonding between the polymer 302 and the fiber optic cable 303 and mechanical steps 301. The polymer 302 may be provided to or applied to the fiber optic cable 303 by, for example, extrusion or other appropriate techniques. The mechanical steps 301 are intended to prevent the polymer 302 from sliding on the fiber optic cable 303. In further cases, the mechanical steps 301 may have other shapes or designs; for example, saw tooth, triangular, semi-circular or the like.

When external pressure is applied transversely to the sensor 300, deformation of the extruded polymer 302 occurs, causing volume changes based on the pressure and the Young's modulus of the extruded polymer 302. Due to the volume change in the transverse direction, the polymer will be elongated axially to compensate for the force induced by the volume change. The extruded polymer 302 interfaces with the mechanical steps 301 and converts the effects of deformation into an axial strain in the FBG section 304. The difference in Young's modulus of 302 and 303 results in an induced axial force on the fiber causing a loading strain in the FBG section and the coating 305. The difference in thermal expansion coefficient between the components of the sensor 300, for example, the FBG section 304, the inner epoxy 307 and the coating 305, results in different induced strain profile based on different external temperature.

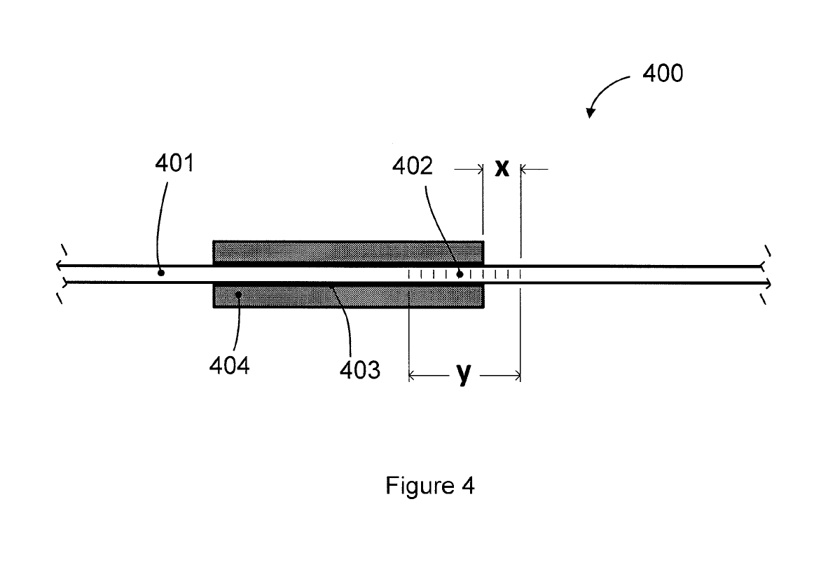

FIG. 4 illustrates an embodiment of a dual-parameter optical sensor 400; and in particular, a sensor for both temperature and strain/pressure. The sensor 400 includes a fiber optic cable 401, a fiber Bragg grating (FBG) section 402, an adhesive/sealant 403, and a sleeve 404. The adhesive/sealant may be, for example, any suitable adhesive or sealant that can bind metal with silica.

The sleeve 404 may be made of metal, for example, invar, aluminum, stainless steel, magnesium or of other appropriate materials, for example, graphene or the like. The sleeve 404 may have an inner diameter in the range of approximately 200 microns to 1 mm and a length in the range of approximately half of the grating length to approximately 2 cm. In a particular case, half of the grating length is approximately 1 mm. In some cases, the sleeve 404 may be formed by using a commercially available needle that is sized appropriately. The sleeve 404 is selected to have a thermal expansion coefficient that is different from that of the fiber optic cable 401 and/or the adhesive/sealant 403.

The sleeve 404 is affixed to the fiber optic cable 401 using the adhesive/sealant 403 such that only a portion of the FBG section 402 is covered by the sleeve 404. As indicated by the different dimensions of “x” and “y” in FIG. 4, the FBG section 402 is only partially covered. The relationship between x and y is such that x should be less than y; however, the dimensions are generally selectable based on the particular requirements for the sensor. In some cases, the relationship between the dimensions of x and y is such that x, the unenclosed portion of the FBG section 402, is less than or equal to half of y, the total length of the FBG section 402 (x<=0.5 y). In a particular case, x may be dimensioned to be approximately 5 mm and y may be dimensioned to be approximately 10 mm.

The adhesive/sealant 403 may be; for example, UV Cured epoxy, thermal cured epoxy, room temperature fast curing epoxy, or the like. In some cases, the adhesive/sealant 403 may have both adhesive and sealant capabilities. In a particular case, the adhesive/sealant 403 is chosen to solidify and bond at high temperatures such that it is above the normal operating temperature of the sensor 400; for example, a temperature of approximately 100° C. or greater.

A difference in thermal expansion coefficient between the sleeve 404 and the fiber optic cable 401 and/or the adhesive/sealant 403 has been found to result in two peaks in the optical response of the FBG section 402. The two peaks in the sensor response are believed to be due to the difference in thermal expansion between the sleeve 404 and the fiber optic cable 401 and/or the adhesive/sealant 403, inducing thermal residual stresses in the solidified adhesive/sealant 403. When subjected to a temperature change, the region of the FBG section 402 covered with the sleeve 404 is believed to have a higher thermal expansion than the uncovered region (x) of the FBG section 402. The difference in expansion produces a different temperature sensitivity profile shown by Bragg wavelength shifts in the optical spectrum. In a particular case, the thermal expansion property may be optimized based on the total shift of the FBG wavelength to ensure that the desired operational temperature range is detectable. This optimization can be used as a guideline for selecting the thermal expansion properties of the materials. For example, in some cases, it may be preferable to limit the total range of FBG shift to approximately 1 nanometer, corresponding to a temperature change of approximately 0 to 300° C.

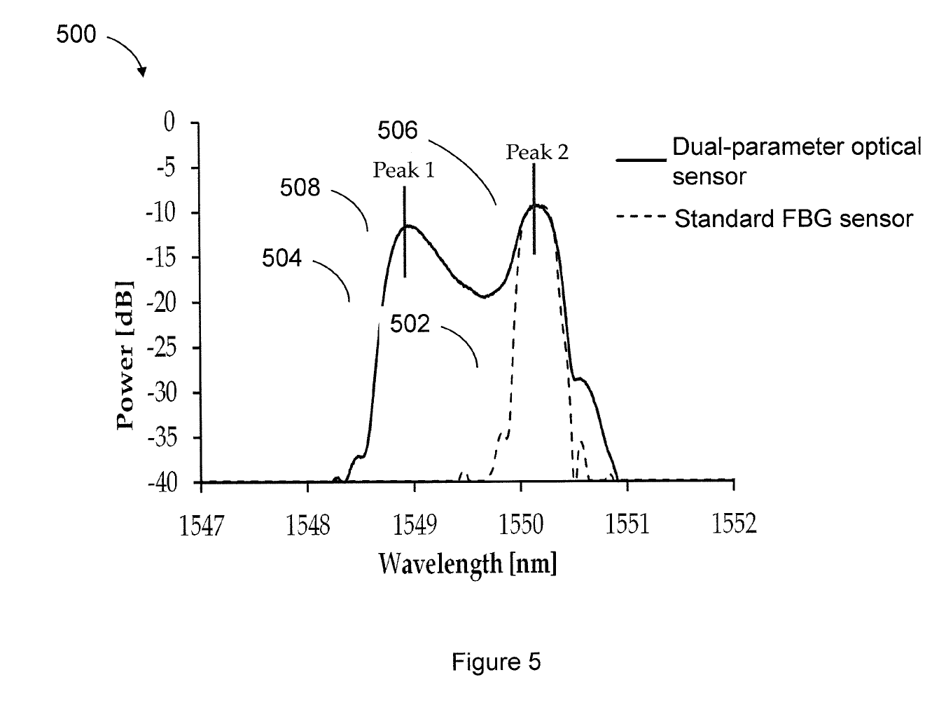

Turning to FIG. 5, a graph illustrating an example of an optical spectrum of the dual-parameter optical sensor 400 is shown. The stippled line represents an example optical spectrum response 502 at room temperature of a standard FBG sensor, which does not comprise a sleeve. In contrast, the solid line represents an example optical spectrum response 504 at room temperature of the dual-parameter optical sensor 400 as described in the embodiment of FIG. 4. Both the standard FBG sensor optical spectrum 502 and the dual-parameter optical sensor 400 response 504 share a peak power response labelled as Peak 2 506. For the response 504 of the dual-parameter optical sensor 400, Peak 2 506 corresponds to the response from the uncovered (x) portion of the FBG section 402. Only the response 504 of the dual-parameter optical sensor 400 has an additional peak at Peak 1 508. Peak 1 508 corresponds to the response from the covered portion of the FBG section 402. Peak 1 508 emerges due to the mismatch of the coefficients of thermal expansion between the components of the dual-parameter optical sensor 400; for example, between the sleeve 404, in this case a metallic insert, the adhesive/sealant 403, in this case formed out of polymeric thermal cured epoxy, and the fiber optic cable 401. Peak 2 506 of the dual-parameter optical sensor 400 response 504, which coincides with the peak of the response 502 of a standard FBG sensor, is generally known in the art. As such, Peak 2 506 is typically used by a single-parameter optical sensor for calculation of the parameter. As will be described, the dual-parameter optical sensor 400 uses the additional peak, Peak 1 508, resulting from the difference in thermal expansion coefficient, to determine the dual parameters; for example, force and temperature.

In the preceding embodiments, the dual-parameter (for example, pressure and temperature) sensing can be achieved by monitoring and analysis of the optical spectrum response of the dual-parameter optical sensor 400. Monitoring can include main peak, side band peaks, and the main peak bandwidth. These variables can be used to determine the main peak wavelength shift and the relative side band peak shift. Linear regression, autoregressive with exogenous (ARX) or autoregressive moving average with exogenous (ARMAX) modeling may then be used to determine correlations between side band shift and/or width with respect to temperature and pressure. In some cases, a digital low pass filter, for example, a weighted moving average filter, may be used to reduce measurement noise.

As an example, for the embodiment of FIG. 4, dual-parameter sensing can be achieved by monitoring and analysis of the peaks of the optical spectrum response, as exemplified in FIG. 5. Upon initial calibration to yield a sensor calibration constants matrix, differences in the shift of the optical spectrum responses for each of the peaks can be used to calculate the parameters of force and temperature. As the shift of temperature and force vary with a high degree of linearity, measurements of Peak 1 508 and Peak 2 506 can be used to calculate the desired parameters.

The sensitivity of sensor 400, having an FBG section 402 with sleeve 404, may be calibrated using the following relationship:

$$⌊ \begin{matrix}Δ {λ}_{{B}_{1}} \\ Δ {λ}_{{B}_{2}}\end{matrix} ⌋ = [ K ] [ \begin{matrix}Δ F \\ Δ T\end{matrix} ]$$

$$⌊ \begin{matrix}Δ {λ}_{{B}_{1}} \\ Δ {λ}_{{B}_{2}}\end{matrix} ⌋ = [ \begin{matrix}{K}_{{F}_{1}} & {K}_{{T}_{1}} \\ {K}_{{F}_{2}} & {K}_{{T}_{2}}\end{matrix} ] [ \begin{matrix}Δ F \\ Δ T\end{matrix} ]$$

Where Δλ_{B1} represents changes in peak 1, Δλ_{B2} represents changes in peak 2, [K] represents the calibration constants matrix, F represents force, and T represents temperature.

One example implementation yields a sensor calibration matrix with the following constants:

K_{F}_{₁}=0.1031, K_{T}_{₁}=0.0269

K_{F}_{₂}=1.2597, K_{T}_{₂}=0.0108

By inverting matrix [K], environment variables, such as force and temperature imposed on the FBG section 402, may be predicted by measurements of Peak 1 508 and Peak 2 506, and using the following relationship:

$$[ \begin{matrix}Δ F \\ Δ T\end{matrix} ] = {[ K ]}^{- 1} ⌊ \begin{matrix}Δ {λ}_{{B}_{1}} \\ Δ {λ}_{{B}_{2}}\end{matrix} ⌋$$

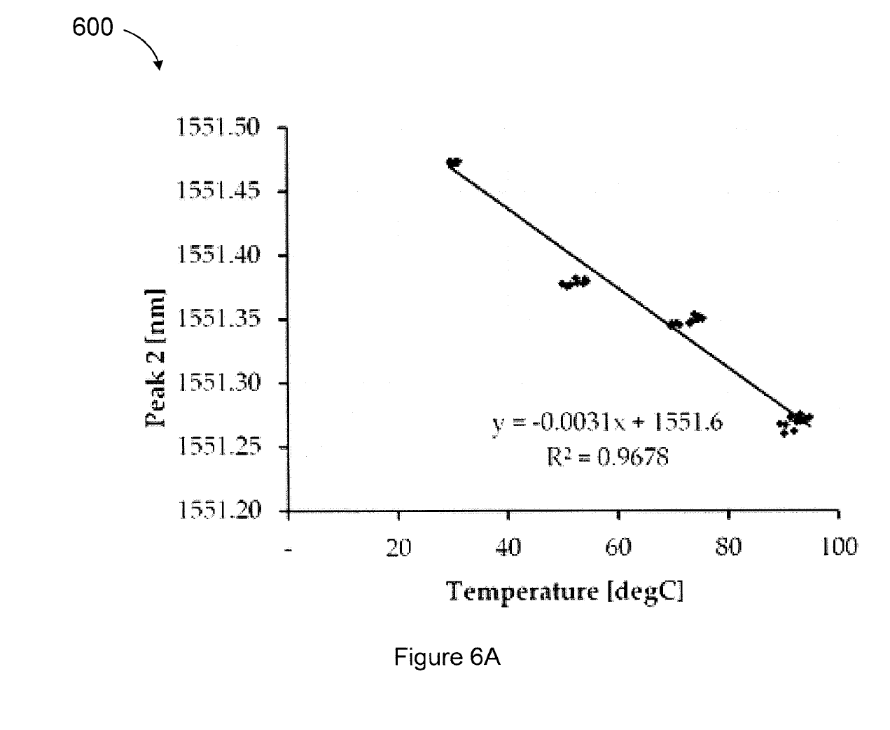

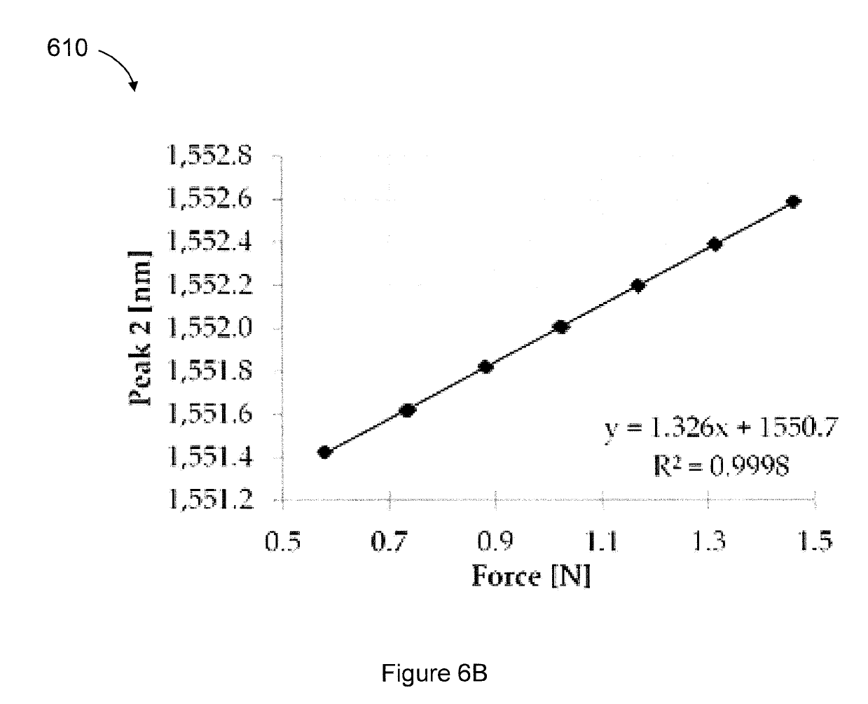

Turning to FIG. 6A, a graph illustrating an example of the temperature sensitivity 600 of the dual-parameter optical sensor 400 is shown. The temperature sensitivity 600 is shown for Peak 2 506 in the optical spectrum response 504 of the dual-parameter optical sensor 400. The Peak 2 506 shift varies due to temperature variation. The sensitivity 600 of Peak 2 506 is believed to have a negative correlation with temperature due to the larger thermal expansion of the neighboring covered portion of the FBG section 402 (associated with Peak 1 508). The expansion of the covered section may cancel out the expansion of the uncovered (x) portion of the FBG section 402, which may be silica.

Turning to FIG. 6B, a graph illustrating an example of the force sensitivity 610 of the dual-parameter optical sensor 400 is shown. The force sensitivity 610 is shown for Peak 2 506 in the optical spectrum response 504 of the dual-parameter optical sensor 400. The Peak 2 506 shift varies due to force variation. The sensitivity of force of the uncovered portion of the FBG section 402 is approximately 1.326 nm/N, which is equivalent to approximately 1.17 pm/microstrain. The sensitivity agrees with the sensitivity of a standard FBG fiber, which typically has sensitivity of approximately 1.20 pm/microstrain.

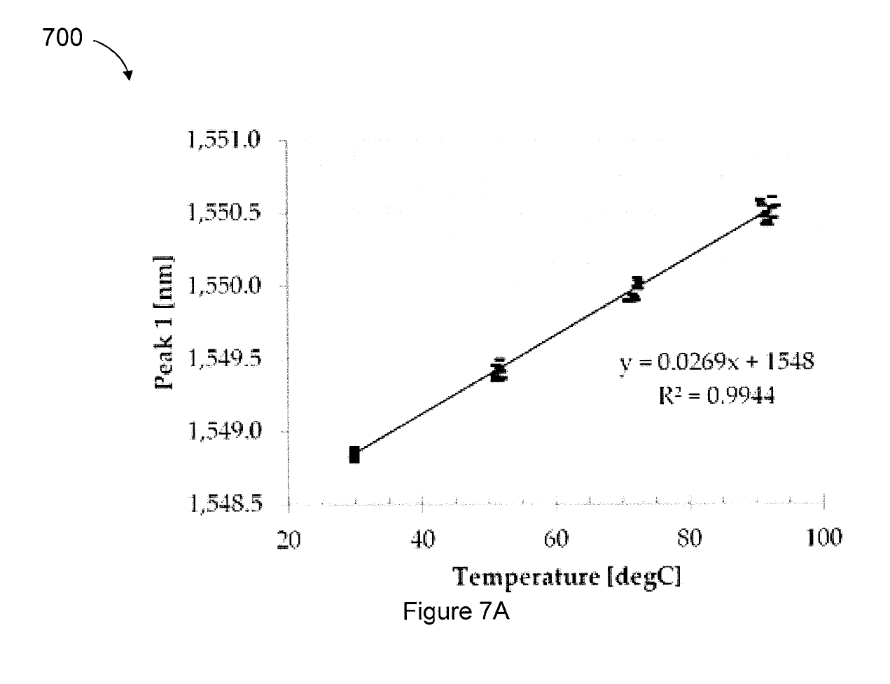

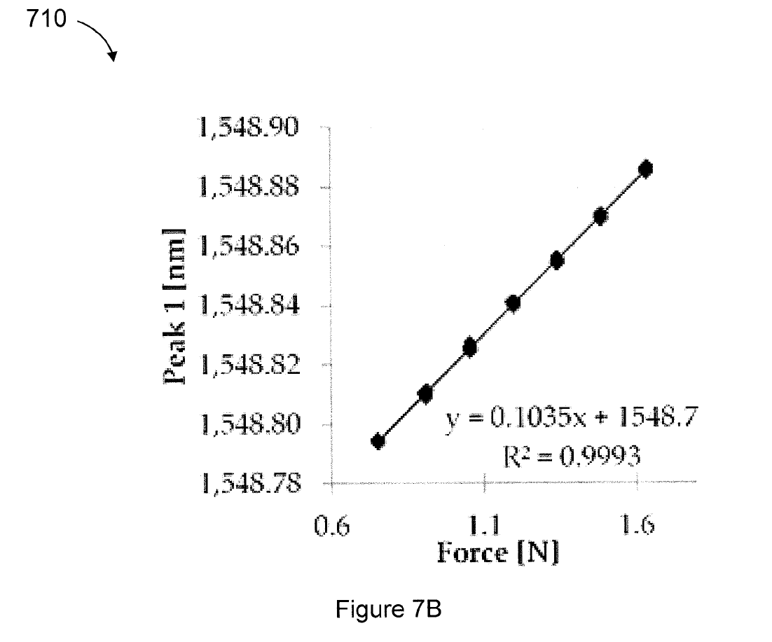

Turning to FIG. 7A, a graph illustrating an example of the temperature sensitivity 700 of the dual-parameter optical sensor 400 is shown. The temperature sensitivity 700 is shown for Peak 1 508 in the optical spectrum response 504 of the dual-parameter optical sensor 400. The Peak 1 508 shift varies due to temperature variation. As shown, the temperature sensitivity has a high degree of linearity. In this example, Peak 1 508 has a temperature sensitivity of 26.9 pm/° C., which would be almost three times higher than conventional temperature sensitivity for standard FBG fiber.

Turning to FIG. 7B, a graph illustrating an example of the force sensitivity 710 of the dual-parameter optical sensor 400 is shown. The force sensitivity 710 is shown for Peak 1 508 in the optical spectrum response 504 of the dual-parameter optical sensor 400. As shown, the force sensitivity also has a high degree of linearity. In this example, Peak 1 508 has a force sensitivity of 103.5 pm/N, which would be almost thirteen times attenuation from the conventional force sensitivity of standard FBG fiber.

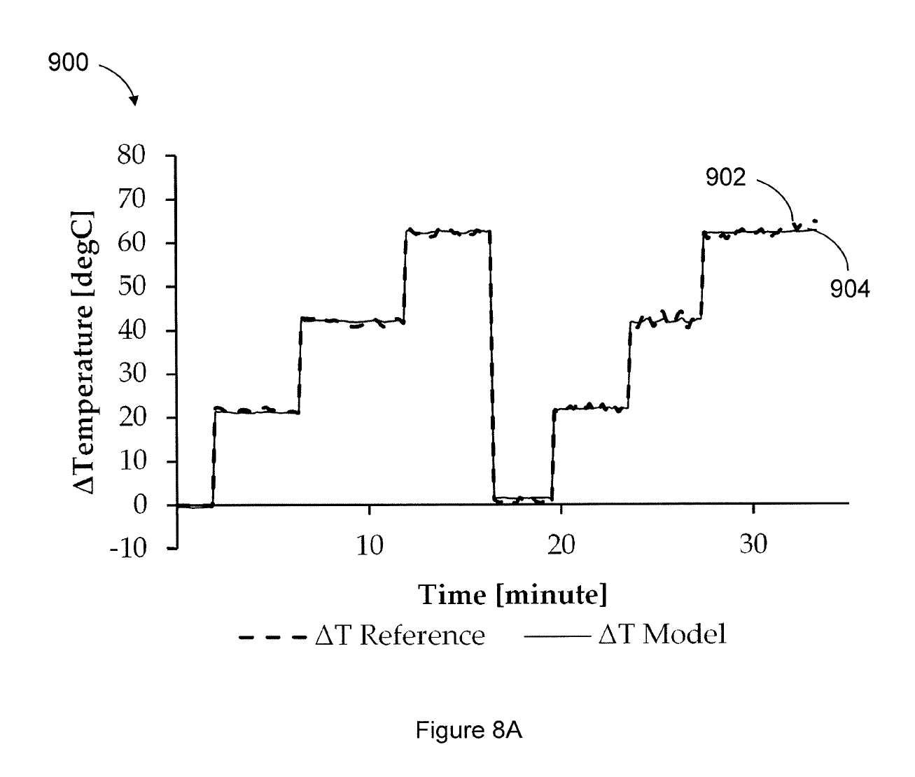

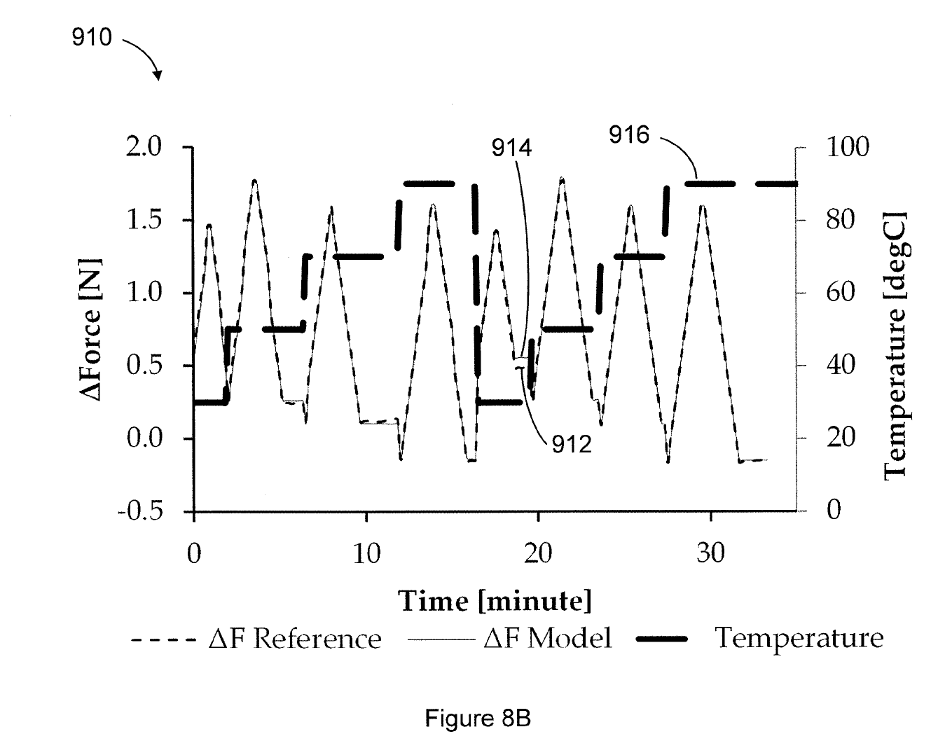

FIG. 8A is a graph illustrating an example model validation of the sensor performance for changes in temperature 800. FIG. 8B is a graph illustrating an example model validation of the sensor performance for changes in force 810. For the example of FIGS. 8A and 8B, the dual-parameter optical sensor of FIG. 4 was mounted on a calibration station which supplied tensile displacement and step temperature change in successive sequence. Optical response of the dual-parameter optical sensor was then captured. Reference temperature, as in FIG. 8A, was measured by a type T thermocouple, and force, as in FIG. 8B, was measured by a force sensor. The model response, shown in FIGS. 8A and 8B, is the prediction of temperature and force applied respectively, given the measurement of Peak 1 and Peak 2 shifts in the dual-parameter optical sensor. As shown in FIG. 8A, the model temperature 804 performance is substantially similar to the reference temperature 802 performance. Similarly, as shown in FIG. 8B, the reference force 812 performance is substantially similar to the model force performance 814 across similar changes in temperature 816.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

The above-described embodiments are intended to be examples only. Alterations, modifications and variations can be effected to the particular embodiments by those of skill in the art without departing from the scope herein.

What is claimed is:

1. A dual-parameter optical sensor comprising:
a fiber optic cable;
a fiber Bragg grating (FBG) section provided on the fiber optic cable; and
a sleeve affixed to the fiber optic cable such that the sleeve encloses a predetermined portion of the FBG section, wherein the sleeve has a different thermal expansion co-efficient than the fiber optic cable.

2. The dual-parameter optical sensor of claim 1 wherein the sleeve is comprised of metal selected from the group consisting of invar, aluminum, stainless steel, and magnesium.

3. The dual-parameter optical sensor of claim 1 wherein the sleeve is formed from a commercially available needle.

4. The dual-parameter optical sensor of claim 1 wherein the sleeve is comprised of graphene.

5. The dual-parameter optical sensor of claim 1 wherein the predetermined enclosed portion of the FBG section is longer than an unenclosed portion of the FBG section.

6. The dual-parameter optical sensor of claim 1 wherein the ratio of the unenclosed portion of the FBG section to the entire FBG section is approximately less than or equal to 0.5:1.

7. The dual-parameter optical sensor of claim 1 wherein an optical response of the sensor provides two peaks, a first peak B₁ and a second peak B₂, the dual parameters are temperature (T) and pressure (F) and the parameters are calculated using the following relationship:
$$[ \begin{matrix}Δ F \\ Δ T\end{matrix} ] = {[ K ]}^{- 1} ⌊ \begin{matrix}Δ {λ}_{{B}_{1}} \\ Δ {λ}_{{B}_{2}}\end{matrix} ⌋$$
where K is a calibration matrix determined by calibrating the optical sensor.

8. The dual-parameter optical sensor of claim 1 wherein the sleeve has a diameter in the range of approximately 200 microns to 1 mm and the sleeve has a length in the range of 1 mm to 2 cm.

9. A dual-parameter optical sensor comprising:
a fiber optic cable;
a fiber Bragg grating (FBG) section provided on the fiber optic cable;
a coating affixed to the fiber optic cable such that the coating encloses at least a predetermined portion of the FBG section, wherein the coating has a different thermal expansion co-efficient than the fiber optic cable;
at least one mechanical element attached to the fiber optic cable and configured to move axially when the optical sensor is placed under pressure; and
an enclosure enclosing the coating, the mechanical element and at least a portion of the fiber optic cable.

10. The dual-parameter optical sensor of claim 9, wherein the enclosure comprises a polymer.

11. The dual-parameter optical sensor of claim 10, wherein the polymer is selected from the group comprising a high density polyethylene, polyurethane, hytrel, polybutylene, or composite graphene-polymer.

12. The dual-parameter optical sensor of claim 9, wherein the coating has a conic or parabolic profile.

13. The dual-parameter optical sensor of claim 9 further comprising:
a fixed end piece joined to a portion of the sleeve; and
wherein the mechanical element comprises a moving end piece slidably engaged with the enclosure.

14. The dual-parameter optical sensor of claim 13, wherein the fixed end piece and the moving end piece define a space between the fixed end piece and the moving end piece, and the enclosure comprises a hole for providing access to the space.

15. A method for manufacturing a dual-parameter optical sensor, the method comprising:
selecting a fiber optic cable having a predetermined thermal expansion coefficient;
forming a fiber Bragg grating (FBG) section on the fiber optic cable;
selecting a sleeve having a predetermined thermal expansion co-efficient that is different from the thermal expansion co-efficient of the fiber optical cable;
selecting a predetermined portion of the FBG section to be enclosed by the sleeve; and
joining the fiber optic cable to the sleeve such that the sleeve encloses the selected predetermined portion of the FBG section.
